(19) United States
(12) Patent Application Publication
(10) Pub. No.: US 2010/0270806 A1
(43) Pub. Date: Oct. 28, 2010

(54) VERTICAL AXIS WIND TURBINE

(76) Inventor: Valentine Labrado Estrada, El Paso, TX (US)

Correspondence Address: Ortiz and Lopez, PLLC, P.O. Box 4484, Albuquerque, NM, 87196, US

(21) Appl. No.: 12/429,550

(22) Filed: Apr. 24, 2009

(51) Int. Cl. F03D 9/00

(52) U.S. Cl. 290/55

(57) ABSTRACT

A vertical axis wind turbine apparatus can be implemented as a support structure, atop which is located a rotatable domed housing for a blade assembly. The blade assembly includes curved blades vertically attached to a drive shaft which can either turn a magnetic rotor or be attached directly to a generator in order to produce electricity. The blade assembly receives wind through both a main inlet and a secondary inlet and expels wind through an exhaust duct. The device can be constructed from carbon fiber to prevent damage from lightning. The device is also constructed with the appearance of a tree where the support structure resembles a tree trunk and panels resembling palm fronds or branches can be attached to the domed housing. The design creates an efficient and aesthetically pleasing wind turbine that can be utilized in both residential and commercial applications.

### TECHNICAL FIELD

Embodiments are generally related to wind driven power generating systems. Embodiments are also related to vertical axis wind turbines housed in domed structures. Embodiments are particularly related to aesthetically acceptable vertical axis wind turbine power generating systems useful for the production of power, such as electricity, in commercial and residential settings.

### BACKGROUND OF THE INVENTION

Wind power generating systems are currently used around the world in various settings to produce power, particularly electricity. Commonly, commercial wind driven generators operate as horizontal axis (i.e. axis of rotation is horizontal) wind turbines which have blades that rotate vertically around a horizontal axis, similar to a propeller on an airplane. These propeller turbines are the kind typically seen on large wind farms. Propeller turbines need to be oriented perpendicular to the direction of the wind to be efficient, and they are generally placed as high as possible to take advantage of higher wind speeds.

An alternative to the horizontal axis wind generators is the Vertical Axis Wind Turbine (VAWT), which utilizes blades that are oriented vertically around a center shaft or pole. Some advantages of VAWTs are that they can generate electricity at much lower wind speeds and can continue to generate power in high wind speeds, depending on the mode. VAWTs are also not dependent on being positioned in any particular orientation with respect to wind direction, thus, they can be utilized in areas where wind direction is highly variable.

There are generally two modes of operation for VAWTs; drag-based designs and lift-based designs. The lift-based design uses lift forces generated by the wind hitting airfoils to create rotation. They have good efficiency, but produce large torque ripple and cyclic stress on the tower, which contributes to poor reliability. Also, they generally require some external power source to start turning, because the starting torque is very low. The drag-based device utilizes two (or more) scoops or curved blades, similar to those used in anemometers. Advantages of this type of machine are that it is self-starting and does not require aiming into an incident wind direction. However, existing VAWTs are also susceptible to interference by birds and tend to be aesthetically unacceptable to the public. Additionally, VAWTs that are manufactured using metals can be vulnerable to lightning strikes.

Unfortunately, existing wind turbine designs have not been as widely adapted as is economically feasible. There are inevitable problems with public reaction to the unsightly nature of the turbines and their visual dominance on a landscape. There are also other issues. Existing wind turbines are often high off the ground which increases maintenance costs due to poor accessibility and some turbines have had to reduce their operating speed due to birds colliding with the turbine blades. Therefore, it is believed that a need exists for a vertical-axis wind turbine that can be housed in a domed structure for use in both residential and commercial settings to produce electricity in an efficient and safe manner. It is also believed that a need exists for aesthetically pleasing wind turbines in order to reduce public opposition to their use.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is therefore, one aspect of the present invention to provide for an improved vertical axis wind turbine.

It is another aspect of the present invention to provide for an aesthetically pleasing vertical axis wind turbine manufactured to resemble a tree.

The aforementioned aspects and other objectives and advantages can now be achieved as described herein. A vertical axis wind turbine apparatus is disclosed, which can be implemented in the form of a support structure, atop which is located a rotatable domed housing for a blade assembly. The blade assembly includes partially curved blades vertically attached to a drive shaft which can either turn a magnetic rotor or be attached directly to a generator in order to produce electricity. The blade assembly receives wind through both a main inlet and a secondary inlet and expels wind through an exhaust duct. The device can be constructed from carbon fiber, when possible, so as to prevent damage from lightning. The device is also constructed to have the appearance of a tree where the support structure is designed to resemble a tree trunk and panels resembling palm fronds or branches with leaves can be attached to the domed housing. The design permits use of wires to transport generated electricity to the grid through an inverter and a control panel. This design creates an efficient and aesthetically pleasing wind turbine that can be utilized in both residential and commercial application.

### BRIEF DESCRIPTION OF THE DRAWINGS

FIG. 1 illustrates a side view of a vertical axis wind turbine 100 utilizing a domed housing 10 incorporated into a structure having the appearance of a palm tree.

FIG. 2 illustrates the front view of a vertical axis wind turbine 100.

FIG. 3 illustrates a blade assembly 40 located inside the domed housing 10.

FIG. 4 illustrates the top view of the inside of the domed housing 10.

FIG. 5 illustrates the transport of electricity produced by the vertical axis wind turbine.

### DETAILED DESCRIPTION

The particular values and configurations discussed in these non-limiting examples can be varied and are cited merely to illustrate embodiments and are not intended to limit the scope of the embodiments.

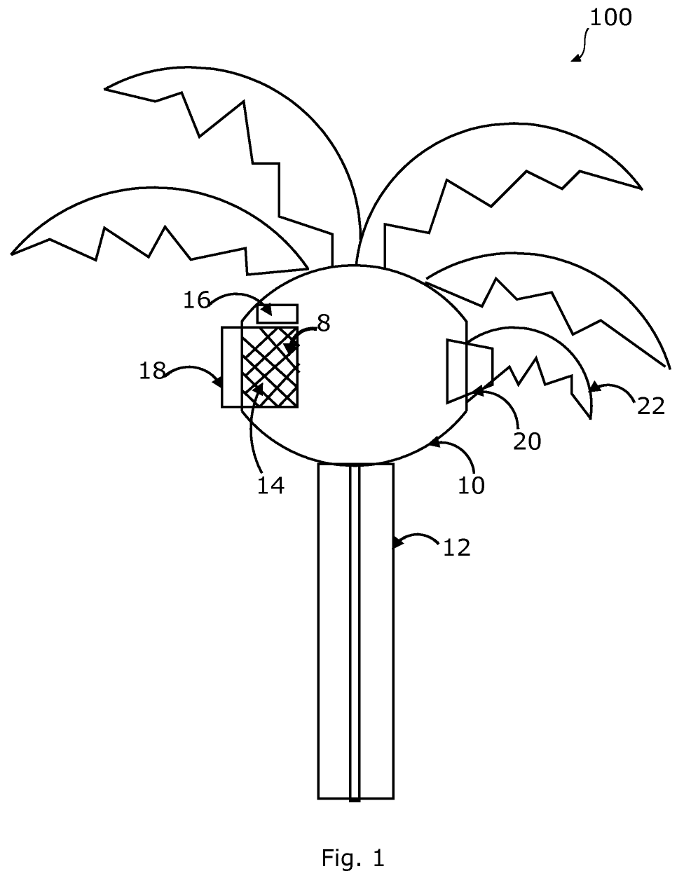

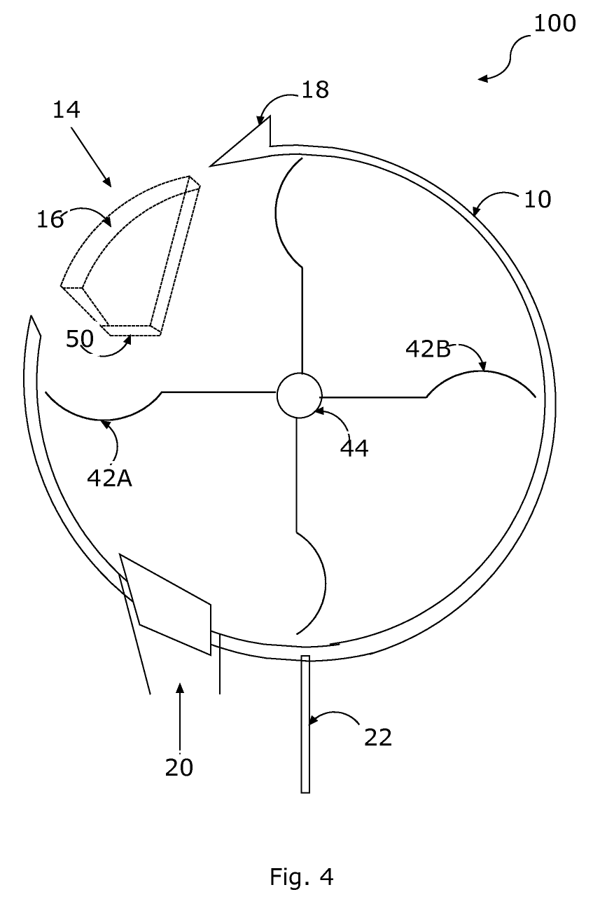

FIG. 1 illustrates a side view of a vertical axis wind turbine 100 utilizing a domed housing 10 incorporated into a structure having the appearance of a palm tree. It should be noted that the palm tree is used to illustrate possible aesthetic options, but the structure can be modeled after any number of tree species to suit the local landscape or customer preference. The domed housing 10 is rotatably positioned atop a support structure 12. The domed housing 10 includes a main inlet 14 opening through which wind can enter the domed housing 10. The main inlet 14 can include an angled tip 18 protruding out from the domed housing 10 to catch and direct wind into the main inlet 14. In order to prevent birds or debris from entering the housing 10 a screen 8 can be placed so as to cover the main inlet 14. A secondary inlet 16 is located at mid curve of the upper portion of the domed housing 10 in order to capture low pressure wind flowing over the domed housing 10 to supplement wind entering through the main inlet 14. The secondary inlet 16 is located above the main inlet 14 on the upper curve of the domed housing 10 such that supplemental wind is forced down at an angle onto the accepting blades 42A (shown in FIG. 4), thus providing more force on the blades 42 causing them to rotate faster. An exhaust duct 20 is located opposite the main inlet 14 to allow wind to escape. A rigid, vertically oriented rudder 22 can be placed at the rear of the domed housing 10 to aid the domed housing 10 in rotating so that the main inlet 14 is positioned into oncoming wind. Many of the afore described components can be manufactured out of carbon fiber so that they would be strong and lightweight, as well nonconductive to avoid possible damage by lighting.

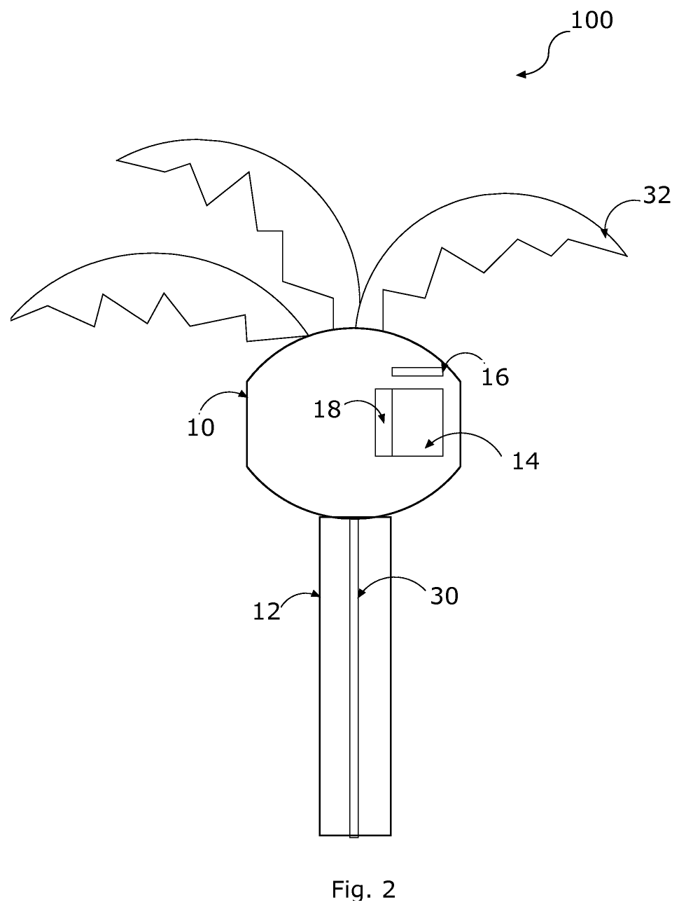

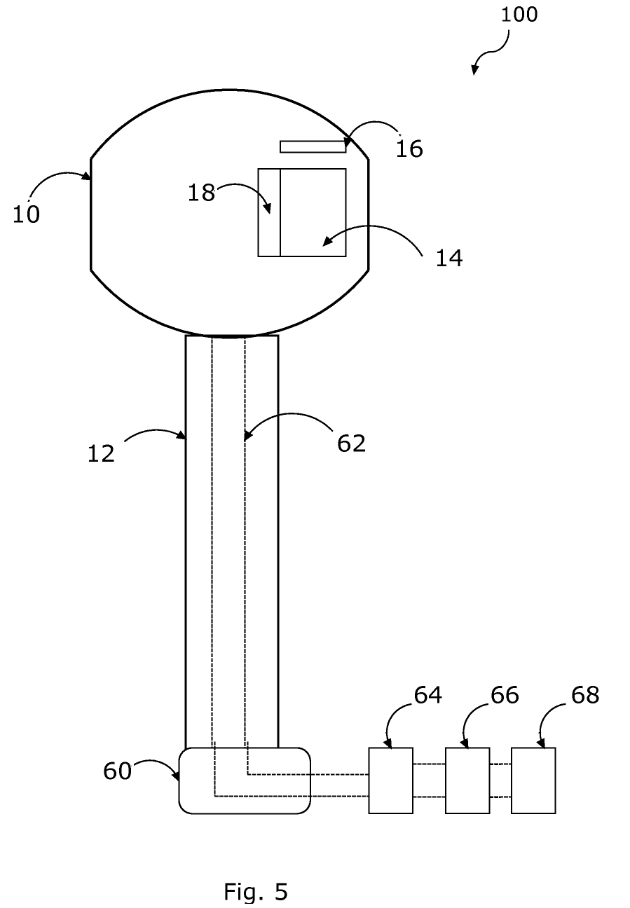

FIG. 2 illustrates the front view of a vertical axis wind turbine 100. The main inlet 14 is off set within the domed housing 10 so as to direct wind onto the accepting blades and to prevent wind from interfering with the blades as they return. In one embodiment, a drive shaft 30 can be located within the support structure 12 in order to turn a generator 60 (shown in FIG. 5) located at the base of the support structure 12 in order to produce electricity. Note that in FIGS. 1-5, identical or similar parts or elements are generally indicated by identical reference numerals. The angled tip 18 is positioned on the inner side of the main inlet 14 so as to increase the amount of wind directed into the main inlet 14. Manufactured panels resembling leaves 32 can be attached to the domed housing 10 to camouflage the structure and make it more aesthetically appealing for use in residential or commercial areas where the public might be opposed to typical wind turbines.

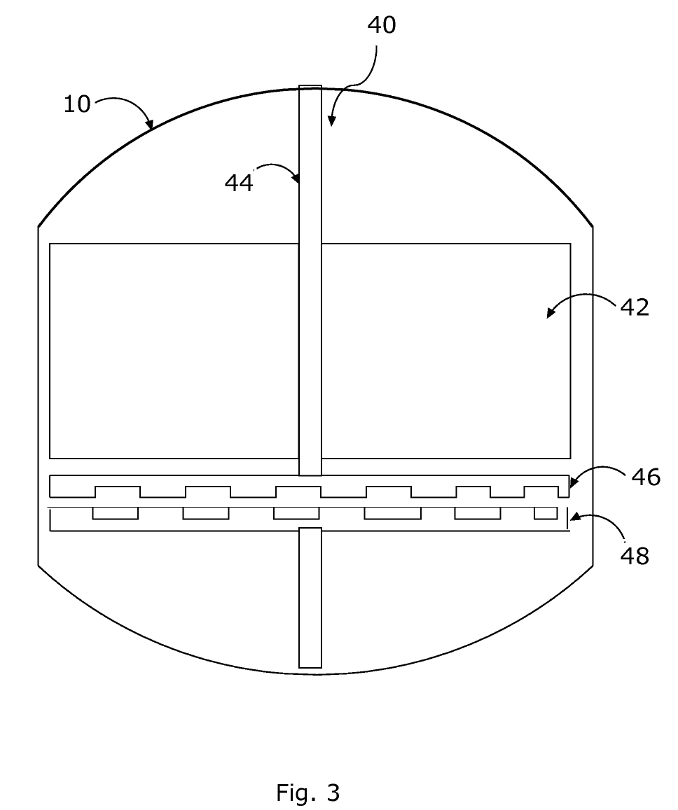

FIG. 3 illustrates a blade assembly 40 located inside the domed housing 10. The blade assembly 40 includes multiple blades 42 vertically attached to an internal drive shaft 44 which is located in the center of the domed housing 10 in such a way as to allow it to rotate. The blades 42 are shaped so that they include a flat portion that is connected to the internal drive shaft 44 and a curved outer portion for holding the wind to produce rotation. In an alternate embodiment, a magnetic rotor 46 is also attached to the internal drive shaft 44 and a fixed stator 48 is positioned below the magnetic rotor 46 to allow for indirect contact, thus producing electricity when the internal drive shaft 44 turns as a result of wind pushing on the blades 42.

FIG. 4 illustrates the top view of the inside of the domed housing 10. The internal structure of the secondary inlet 16 is also illustrated. Within the domed housing 10 a flat, funneled structure 50 is located so as to concentrate wind coming through the secondary inlet 16 and force it downward at an angle onto the blades 42. This serves to supplement the wind coming through the main inlet 14 in order to provide a greater force against the blades 42, thus increasing the efficiency of the turbine 100 at lower wind speeds. FIG. 4 also illustrates the off set positioning of the main inlet 14 and exhaust duct 20 within the domed housing 10 to allow wind to be directed onto the accepting blades 42A while shielding the returning blades 42B from the oncoming wind.

FIG. 5 illustrates the transport of electricity produced by the vertical axis wind turbine. Again, electricity can be produced by the turbine 100 by two different methods. The domed housing 10 can contain the magnetic rotor 46 which works with the fixed stator 48 to produce electricity through indirect contact or the blade assembly 40 can be used to turn a drive shaft 30 which then drives a generator 60 located at the base of the support structure 12. Wires 62 can be provided that carry the generated electricity to an inverter 64, if necessary, and then to a control panel 66, which allows the electricity to be utilized onsite or it can be routed to the grid connection 68.

What is claimed is:

1. A vertical axis wind generator for producing electricity, comprising:
a blade assembly comprising a plurality of blades vertically attached to a drive shaft;
a domed housing wherein said blade assembly is rotatably located within said domed housing;
a main inlet in said housing so as to allow wind onto said plurality of blades;
an angled flap protruding from the outer surface of said domed housing so as to catch and direct oncoming wind into said main inlet;
an exhaust duct located opposite said main inlet; and
a support structure upon which said domed housing is rotatably positioned.

2. The apparatus of claim 1 further comprising:
a magnetic rotor attached to said drive shaft;
a fixed stator located below said magnetic rotor so as to make indirect contact with said magnetic rotor in order to produce electricity when said magnetic rotor rotates.

3. The apparatus of claim 1 further comprising a secondary inlet located above said main inlet in curve of said domed housing to receive wind and direct it downward onto said plurality of blades.

4. The apparatus of claim 1 wherein said support structure is manufactured to look like a tree trunk.

5. The apparatus of claim 1 further comprising manufactured tree leaves attached to said domed housing.

6. The apparatus of claim 1 further comprising a vertically oriented rigid rudder attached to said domed housing to position said main inlet into oncoming wind.

7. The apparatus of claim 5 wherein said rigid rudder is manufactured with the appearance of a tree leaf.

8. The apparatus of claim 1 further comprising wires that carry generated electricity to the electrical grid.

9. The apparatus of claim 8 further comprising an inverter.

10. The apparatus of claim 8 further comprising a controller panel.

11. The apparatus of claim 1 further comprising carbon fiber.

12. A vertical axis wind powered electric generator resembling a tree, comprising:
a support structure resembling a tree trunk;
a blade assembly comprising a plurality of blades vertically attached to a drive shaft;
a domed housing rotatably located atop said support structure wherein said blade assembly is rotatably located;
a main inlet in said housing so as to allow wind onto said plurality of blades;
a secondary inlet located on the upper curve of said domed housing;
a rigid rudder vertically attached to said domed housing to steer rotation such that said main inlet is positioned into oncoming wind.
an exhaust duct located opposite said main inlet such that wind can exit said domed housing; and
a plurality of panels resembling leaves attached to said domed housing.

13. The apparatus of claim 12 wherein said drive shaft extends down through said support structure to attach to a generator for producing electricity.

14. The apparatus of claim 12 wherein said rigid rudder is manufactured with the appearance of a tree leaf.

15. The apparatus of claim 13 further comprising wires that carry generated electricity to the electrical grid.

16. The apparatus of claim 15 further comprising an inverter.

17. The apparatus of claim 15 further comprising a controller panel.

18. A vertical axis wind powered electric generator, comprising:
a support structure resembling a palm tree trunk;
a blade assembly comprising a plurality of blades vertically attached to a drive shaft;
a domed housing rotatably located atop said support structure wherein said blade assembly is rotatably located;
a main inlet in said housing so as to allow wind onto said plurality of blades;
a secondary inlet located on the upper curve of said domed housing;
a rigid rudder vertically attached to said domed housing to steer rotation such that said main inlet is positioned into oncoming wind.
an exhaust duct located opposite said main inlet such that wind can exit said domed housing; and
a plurality of panels resembling palm leaves attached to said domed housing.

19. The apparatus of claim 18 further comprising:
a magnetic rotor attached to said drive shaft;
a fixed stator located below said magnetic rotor so as to make indirect contact with said magnetic rotor in order to produce electricity when said magnetic rotor rotates.

20. The apparatus of claim 18 wherein said drive shaft extends down through said support structure to attach to a generator for producing electricity.
